(19) United States
(12) Patent Application Publication
(10) Pub. No.: US 2025/0390916 A1
(43) Pub. Date: Dec. 25, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Taichi FURUKAWA, Tokyo (JP); Tadashi EMORI, Tokyo (JP); Tomohiro OGAWA, Tokyo (JP)

(21) Appl. No.: 19/193,655

(22) Filed: Apr. 29, 2025

(30) Foreign Application Priority Data
Jun. 20, 2024 (JP) 2024-099671

(51) Int. Cl. G06Q 30/0251; G06F 40/40

(52) U.S. Cl. CPC G06Q 30/0269; G06F 40/40

(57) ABSTRACT

An information processing apparatus according to the present application includes a target related information acquisition unit, a user information acquisition unit, and a generation unit. The target related information acquisition unit acquires target information including information of a specific target and target impression information indicating an impression that a user is estimated to have on the specific target. The user information acquisition unit acquires user impression information indicating an impression that the user is determined to have had on the target information. The generation unit generates improvement information including information indicating improvement content related to the target information on the basis of the target information and the target impression information acquired by the target related information acquisition unit and the user impression information acquired by the user information acquisition unit.

### CROSS-REFERENCE TO RELATED APPLICATIONS

The present application claims priority to and incorporates by reference the entire contents of Japanese Patent Application No. 2024-099671 filed in Japan on Jun. 20, 2024.

### BACKGROUND OF THE INVENTION

### 1. Field of the Invention

The present invention relates to an information processing apparatus, an information processing method, and a non-transitory computer-readable storage medium.

### 2. Description of the Related Art

Conventionally, an attempt is made to create information of a specific target so that an impression that the user has on the specific target such as a product or a service becomes a target impression, but there is a possibility that the impression that the user actually has on the specific target is deviated.

Japanese Patent Application Laid-open No. 2019-133455 discloses a technique in which an evaluator is caused to input an evaluation level of an impression received by appreciation of content that is information of a specific target, and a set of the content and the evaluation level of the impression received by the evaluator with respect to the content is used as teacher data for learning of a machine learning model.

However, the above-described conventional technology are limited to estimate the impression that the user has, and there is room for further improvement in terms of improving convenience on the provision side of the specific target.

### SUMMARY OF THE INVENTION

An information processing apparatus according to the present application includes a target related information acquisition unit, a user information acquisition unit, and a generation unit. The target related information acquisition unit acquires target information including information of a specific target and target impression information indicating an impression that a user is estimated to have on the specific target. The user information acquisition unit acquires user impression information indicating an impression that the user is determined to have had on the target information. The generation unit generates improvement information including information indicating improvement content related to the target information on the basis of the target information and the target impression information acquired by the target related information acquisition unit and the user impression information acquired by the user information acquisition unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of information processing according to an embodiment;

FIG. 2 is a diagram illustrating an example of a configuration of an information processing system according to the embodiment;

FIG. 3 is a diagram illustrating an example of a configuration of an information processing apparatus according to the embodiment;

FIG. 4 is a diagram illustrating an example of a user information table stored in a user information storage unit of the information processing apparatus according to the embodiment;

FIG. 5 is a diagram illustrating an example of merge information generated by a generation unit in a processing unit of the information processing apparatus according to the embodiment;

FIG. 6 is a diagram illustrating an example of template information used by the generation unit in the processing unit of the information processing apparatus according to the embodiment;

FIG. 7 is a diagram illustrating an example of a prompt generated by the generation unit in the processing unit of the information processing apparatus according to the embodiment using the template information illustrated in FIG. 6;

FIG. 8 is a diagram illustrating another example of template information used by the generation unit in the processing unit of the information processing apparatus according to the embodiment;

FIG. 9 is a diagram illustrating an example of a prompt generated by the generation unit in the processing unit of the information processing apparatus according to the embodiment using the template information illustrated in FIG. 8;

FIG. 10 is a diagram illustrating an example of impression information before and after improvement provided by a provision unit in the processing unit of the information processing apparatus according to the embodiment;

FIG. 11 is a flowchart illustrating an example of information processing by a processing unit of the information processing apparatus according to the embodiment; and

FIG. 12 is a hardware configuration diagram illustrating an example of a computer that implements functions of the information processing apparatus according to the embodiment.

### DETAILED DESCRIPTION OF THE PREFERRED EMBODIMENTS

Hereinafter, modes (hereinafter referred to as “embodiment”) for implementing an information processing apparatus, an information processing method, and a non-transitory computer-readable storage medium according to the present application will be described in detail with reference to the drawings. Note that the information processing apparatus, the information processing method, and the non-transitory computer-readable storage medium according to the present application are not limited by the embodiment. In addition, each embodiment can be appropriately combined within a range in which the contents of processing do not contradict each other. In the following embodiments, the same parts are denoted by the same reference numerals, and redundant description will be omitted.

### 1. Example of Information Processing

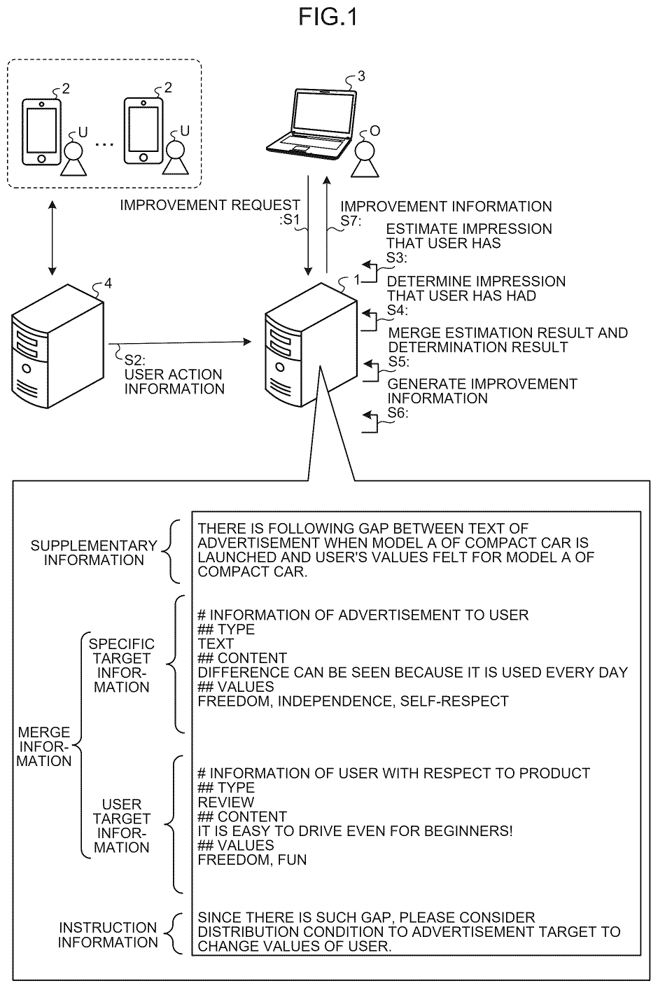

FIG. 1 is a diagram illustrating an example of information processing according to an embodiment, and in the present embodiment, an information processing method is executed by an information processing apparatus 1.

As illustrated in FIG. 1, the information processing apparatus 1 receives an improvement request transmitted from a terminal device 3 of an operator O who creates or provides target information that is information of a specific target (Step S1). The improvement request includes, for example, target information including information of a specific target and improvement directionality information indicating directionality of improvement of the target information.

The specific target is, for example, a product, a service, or the like, but may be an organization such as a company, a facility such as a school or a hospital, a local government such as a city, a town, or a village, or the like, or may be other targets. Specific information is an advertisement or the like for advertising the specific target, and is, for example, a catch phrase, a package, an explanatory sentence, an introductory sentence, or the like of the specific target, but is not limited to such an example. For example, in a case where the specific target is moving image content or music content, the information of the specific target may be moving image content itself or music content itself.

The directionality of improvement of the target information is, for example, directionality of improvement to be closer to an impression that a user U is estimated to have and directionality of improvement to be closer to an impression that the user U is determined to have had, but is not limited to such an example.

For example, the directionality of improvement of the target information may be an intermediate directionality of improvement between the impression that the user U is estimated to have and the impression that the user U is determined to have had, may be directionality of improvement indicating the degree of closeness (for example, 70% close) to the impression that the user U is estimated to have, or may be directionality of improvement indicating the degree of closeness (for example, 80% close) to the impression that the user U is determined to have had.

Furthermore, the improvement request includes user specifying information that is information for specifying a target user U. The target user U is a user U to whom the target information is provided, but is not limited to such an example and may be, for example, a user U to whom the target information is provided and who has purchased or used the specific target. Furthermore, the target user U may be the user U to whom the target information is provided. The user specifying information is, for example, information indicating an attribute of the target user U, information indicating an action of the target user U that is an action of the user U related to the specific target, or the like, but is not limited to such an example.

The action related to the specific target is, for example, posting of a review for the specific target or an answer to a questionnaire for the specific target by the user U, but is not limited to such an example. Furthermore, the action related to the specific target may include an evaluation (for example, a positive evaluation, a negative evaluation, a degree thereof, or the like) action on the specific target posted by the user U, a browsing action on a web page of the specific target by the user U, a search action for the specific target by the user U, and the like. Furthermore, the action related to the specific target may be a comment on the specific target on a social networking service (SNS).

Furthermore, the improvement request may include estimation method type information indicating a type of a method for estimating an impression that the user U has for the specific target. There is a plurality of estimation methods including a first estimation method and a second estimation method as the type of the method for estimating an impression that the user U has on the specific target.

The first estimation method is a method for causing generative artificial intelligence (AI) to directly estimate an impression that the user U has on the specific target. The second estimation method is a method for causing the generative AI to generate, for each impression included in an impression group, reference content on which the user U is estimated to have the impression, and comparing such reference content with the target content to estimate an impression that the user U has on the target content.

Furthermore, the improvement request may include determination method type information indicating the type of the determination method of the impression that the user U has had on the specific target. There is a plurality of determination methods including a first determination method and a second determination method as the type of the method for determining an impression that the user U has had on the specific target. A reception unit 30 receives the determination method type information by receiving the improvement request.

The first determination method is a method of causing the generative AI to directly determine the impression that the user U has had on the specific target. The second estimation method is a method for causing the generative AI to generate, for each impression included in the impression group, reference content on which the user U is determined to have had the impression, and comparing such reference content with the target content to determine the impression that the user U has had on the target content.

Subsequently, the information processing apparatus 1 acquires user action information from an information processing apparatus 4 on the basis of the user specifying information included in the improvement request (Step S2). The user action information is information of the target user U specified by the user specifying information, and is information indicating an action of the user U regarding a specific target for which content is provided on an online site provided by the information processing apparatus 4.

The online site provided by the information processing apparatus 4 is an electronic commerce (EC) site, a news site, a store introduction site, an image posting site, a moving image browsing site, or the like, but is not limited to such an example. The user U can operate a terminal device 2 to use the online site provided by the information processing apparatus 4.

The content of the specific target provided on the online site provided by the information processing apparatus 4 includes content for the user U to perform an action related to the specific target described above, and is, for example, content including content for posting a review for the specific target, content including content for answering a questionnaire for the specific target, or the like, but is not limited to such an example.

The content of the specific target includes the specific information, but is not limited to such an example, and need not include the specific information. The target information is an advertisement including one or more of a package of a specific target, a catch phrase of the specific target, and an explanatory sentence of the specific target, but is not limited to such an example. For example, in a case where the specific target is content, the specific information may be information of the content itself.

As described above, the information indicating the action of the user U regarding the content provided on the online site provided by the information processing apparatus 4, which is the information of the user U specified by the user specifying information, is, for example, posting of a review for the specific target, an answer to a questionnaire by the user U for the specific target, or the like, but is not limited to such an example.

Subsequently, the information processing apparatus 1 estimates the impression that the user U has on the basis of the target information included in the improvement request received in Step S1 (Step S3). In a case where the improvement request received in Step S1 includes the estimation method type information, the information processing apparatus 1 estimates the impression that the user U has by the type estimation method indicated by the estimation method type information. In a case where the improvement request received in Step S1 does not include the estimation method type information, the information processing apparatus 1 estimates the impression that the user U has by the first estimation method.

The generative AI is, for example, text generative AI or multimodal generative AI. The text generative AI is, for example, a large-scale language model learned to estimate and output a next token from an input token string, and is, for example, a transformer-based model, a recurrent neural network (RNN) based model, or the like, but may be a mixed model thereof or the like. Furthermore, the text generative AI may be a composite system combined with an identification machine or the like for preventing unauthorized use.

The transformer-based model is, for example, Generative Pre-trained Transformer (GPT) (registered trademark), PaLM2 (Pathways Language Model Version 2), LLAMA (Large Language Model Meta AI), or the like, but is not limited to such an example. The RNN-based model is, for example, a receptance weighted key value (RWKV) or the like, but is not limited to such an example.

Note that the generative AI is desirably learned so as not to include personal information or the like in the generation result. The generative AI is arranged in an external information processing apparatus and the information processing apparatus 1 uses the generative AI via an API, but the generative AI may be arranged in the information processing apparatus 1.

The multimodal generative AI is, for example, generative AI capable of generating a text or an image from a text, an image, or the like. The multimodal generative AI is, for example, GPT-40, gemini, Claude3, CM3Leon (Chameleon Multimodal Model), or the like, but is not limited to such an example.

First, the first estimation method will be described. On the basis of the target information included in the improvement request received in Step S1, the information processing apparatus 1 estimates, using the generative AI, the impression that the user U has on the specific target from among a plurality of impressions included in the impression group. In the following description, it is assumed that a plurality of impressions included in the impression group is a plurality of impressions IM1 to IMm (m is an integer is equal to or more than 2).

First, the information processing apparatus 1 causes the generative AI to estimate the impression IM that the user U has on the specific target from among the plurality of impressions IM1 to IMm included in the impression group. For example, the information processing apparatus 1 inputs information including instruction information for instructing selection of the impression IM that the user U has on the specific target from among the plurality of impressions IM1 to IMm indicated by the impression information, the impression information indicating the plurality of impressions IM1 to IMm included in the impression group, and the target information to the generative AI as input information, and outputs information indicating one or more impressions IM that the user U is estimated to have on the specific target from the generative AI.

For example, it is assumed that the impression group is an impression group that gives an impression of the values of the user U, and the target information is a sales copy “The difference can be seen because it is used every day”. In this case, the information processing apparatus 1 includes, for example, information of a character string “Please select three or more images that fit the sales copy ‘The difference can be seen because it is used every day.’ from the following values. ¥nValue, Reason” in the input information as the instruction information. In this manner, the instruction information includes the target information included in the improvement request received in Step S1.

In addition, the information processing apparatus 1 includes information including information of a character string “Social power, authority, riches, saving honor, social approval ¥nsuccess, competence, ambition, influence, intelligence ¥nfun, enjoyment of life ¥nbravery, life of change, lively life ¥ncreativity, curiousness, freedom, goal choice, self-respect, independence ¥nenvironmental protection, world of beauty, harmony with nature, generosity, social fairness, intelligence, equality, world peace, inner harmony ¥nassistance, honesty, tolerance, loyalty, responsibility, true friendship, spiritual world, mature love, meaning of life, ¥npoliteness, respect to parents and elders, self discipline, obedience, ¥npiety, acceptance of fate, humility, moderation, respect for tradition, supernatural ¥ncleanliness, national security, social order, household safety, returning a favor, health, belonging feeling” as the impression information in the input information.

Furthermore, for example, instead of the information of the character string “Please select three or more images that fit the sales copy . . . from the following values.”, the information processing apparatus 1 can also use information of “Please select three or more of the following values for the impression that the user is estimated to have on the sales copy . . . ” or information of a character string “Please estimate a score indicating the degree of impression that the user is estimated to have on the sales copy . . . , for each of the following values. The score should be in the range of 1 to 10, and the higher the degree of impression, the larger the value.”, but is not limited to such an example.

Furthermore, the information processing apparatus 1 can also estimate the impression that the user U has on the target information by limiting the attribute of the user U and the like from among the plurality of impressions IM1 to IMm included in the impression group using the generative AI. In this case, for example, instead of the information of the character string “Please select three or more images that fit the sales copy . . . from the following values.”, the information processing apparatus 1 can also use information of “Please select three or more of the following values for the impression that a twenties male is estimated to have on the sales copy . . . ” or information of a character string “Please estimate a score indicating the degree of impression that a twenties male has on the sales copy . . . , for each of the following values. The score should be in the range of 1 to 10, and the higher the degree of impression, the larger the value”. In a case where the generative AI is caused to estimate one or more impressions IM that the user U having an attribute other than twenties male has, the information of the character string “twenties male” can be replaced with information indicating another attribute.

Furthermore, in a case where the target information is image information, the information processing apparatus 1 can input information including the target information, instruction information including information of a character string “Please select three or more images that fit the input image from the following values.”, and the like, and impression information to the multimodal generative AI as input information, and also cause the multimodal generative AI to output the similarity. Note that the information processing apparatus 1 can limit the attribute or the like of the user U or output a score indicating the degree of the impression IM, as in a case where the target information is other than the image information.

Next, the second estimation method will be described. The information processing apparatus 1 causes the generative AI to generate, for each impression IM included in the impression group, reference information on which the user U is estimated to have the impression IM, and compares such reference information with the target information to estimate one or more impressions IM that the user U has on the target information.

The information processing apparatus 1 generates, for each impression IM included in the impression group, reference information on which the user U is estimated to have the impression. In a case where the impression group is an impression group by values based on Schwartz's value theory, the plurality of impressions IM classified by the impression group is the above-described 10 types of values or 56 types of values.

For example, the information processing apparatus 1 inputs, to the generative AI, input information including instruction information that is information instructing generation of reference information on which the user U is estimated to have an impression indicated by the impression IM, and causes the generative AI to generate the reference information. The reference information is, for example, information indicated by at least one of a text or an image.

The information processing apparatus 1 stores fixed instruction information in advance, and inputs information including the fixed instruction information and the information of the impression IM to the generative AI as instruction information to cause the generative AI to generate the reference information for each impression IM. For example, in a case where the specific target is “car” and the target information is a sales copy for the specific target, the fixed instruction information is information of a character string “Post a certain value. Please make 10 sales copies that Japanese users are likely to have the value for the car. Please do not excessively include the posted value in the text”.

Furthermore, the information of the impression IM is, for example, information of a character string “value: social power”. Thus, each of the 10 sales copies on which the user U is predicted to have the impression IM of social power is generated as the reference information.

After generating the reference information for each impression IM, the information processing apparatus 1 compares target information to be estimated of the impression IM that the user U has with the reference information for each impression IM. The information processing apparatus 1 vectorizes the target information and each piece of reference information in order to compare the target information with the reference information for each impression IM.

The information is vectorized by, for example, embedding with a language model (for example, a transformer-based model). The vectorized information is represented by, for example, a vector of several hundred dimensions, but is not limited to such an example.

The embedding by the language model is, for example, embedding by text-embedding-ada, Bidirectional Encoder Representations from Transformers (BERT) provided by OpenAI (registered trademark), or the like, but is not limited to such an example.

Note that vectorization of information is not limited to embedding by a language model, and for example, vectorization of information may be performed by Doc2Vec, an average of word embedding, or the like. For word embedding, for example, Word2Vec, fastText, or the like is used.

For example, the information processing apparatus 1 classifies the target information into the impression IM corresponding to the reference information in which the similarity of the vector to the target information is equal to or more than a threshold. For example, the information processing apparatus 1 can classify the target information into only one impression IM, or can classify the target information into two or more impressions IM.

For example, the information processing apparatus 1 can classify the target information into only one impression IM by classifying the target information into the impression IM corresponding to the reference information in which the similarity of the vector is equal to or more than the threshold and the similarity is the highest.

Furthermore, in a case where the reference information in which the similarity of the vector to the target information is equal to or more than the threshold is two or more, the information processing apparatus 1 can classify the target information into two or more impressions IM respectively corresponding to the two or more pieces of reference information.

The similarity of the vector is cosine similarity, but may be Jaccard similarity or the like, or may be a reciprocal of a Euclidean distance, a reciprocal of a Manhattan distance, or the like. Furthermore, in a case of using the Euclidean distance or the Manhattan distance, the information processing apparatus 1 classifies, for example, target information whose Euclidean distance or Manhattan distance from the reference information is less than a threshold into the impression IM corresponding to the reference information.

Furthermore, the information processing apparatus 1 can learn a classification model by using a vector and corresponding hand-labeled data, and can classify similarity between vectors and the vector by any method such as classifying using the classification model, and further specify similarity between pieces of information or classify information.

Furthermore, in a case where the reference information and the target information are images, the information processing apparatus 1 can also input information including the reference information, the target information, and instruction information indicating an instruction to output similarity between the reference information and the target information to the multimodal generative AI as input information, and output the similarity from the multimodal generative AI.

In this case, for example, the information processing apparatus 1 classifies them into the impression IM corresponding to the reference information having the similarity generated by the multimodal generative AI equal to or more than the threshold and having the highest similarity, and the impression IM corresponding to the reference information having the similarity generated by the multimodal generative AI equal to or more than the threshold.

Furthermore, in a case where the reference information and the target information are images, the information processing apparatus 1 can also cause the multimodal generative AI to generate an explanatory sentence that is a sentence describing what kind of image is included in each of the reference information and the target information.

In this case, the information processing apparatus 1 vectorizes each of an explanatory sentence of the reference information and an explanatory sentence of the target information, and calculates similarity between the vectorized reference information and the vectorized target information. A method of calculating the similarity and a method of classifying the target information into the impression IM are similar to those in the case where the reference information and the target information are texts.

Note that, in a case where the reference information and the target information are images, the information processing apparatus 1 can also calculate the similarity by vectorizing each of the reference information and the target information as it is.

In addition, in a case where the reference information and the target information each include a text and an image, the information processing apparatus 1 classifies them into the impression IM corresponding to the reference information in which an integrated score, which is a score obtained by weighting and adding the similarity between texts and the similarity between images, is equal to or more than a threshold, and the impression IM corresponding to the reference information in which the integrated score is equal to or more than the threshold and is the largest.

Subsequently, the information processing apparatus 1 determines the impression that the user U has had on the basis of the user action information acquired in Step S2 (Step S4). In a case where the determination method type information is included in the improvement request received in Step S1, the information processing apparatus 1 determines the impression that the user U has had by the type determination method indicated by the determination method type information. In a case where the determination method type information is not included in the improvement request received in Step S1, the information processing apparatus 1 determines the impression that the user U has had by the first determination method.

First, the first determination method will be described. The information processing apparatus 1 determines the impression that the user U has had on the specific target from among the plurality of impressions IM1 to IMm included in the impression group using the generative AI.

The information processing apparatus 1 determines the impression that the user U has had on the specific target from among a plurality of impressions included in the impression group on the basis of the user action information acquired in Step S2 using the generative AI. First, the information processing apparatus 1 causes the generative AI to determine the impression IM that the user U has had on the specific target from among the plurality of impressions IM1 to IMm included in the impression group.

For example, the information processing apparatus 1 inputs information including instruction information for instructing selection of the impression IM that the user U has had on the specific target from among the plurality of impressions IM1 to IMm indicated by the impression information, the impression information indicating the plurality of impressions IM1 to IMm included in the impression group, and the user action information acquired in Step S2 to the generative AI as input information, and outputs information indicating one or more impressions IM that the user U is determined to have had on the specific target from the generative AI.

For example, it is assumed that the impression group is an impression group that gives an impression of the values of the user U, the target information is a sales copy “The difference can be seen because it is used every day.”, and the user action information is a posted message “It is easy to drive even for beginners!”. In this case, the information processing apparatus 1 includes, for example, information of a character string “Please select three or more images that the user who made the post ‘It is easy to drive even for beginners!’ with respect to a certain target is determined to have had on the target from the following values. ¥nValue, Reason” in the input information as the instruction information. In this manner, the instruction information includes the user action information acquired in Step S2.

Furthermore, the information processing apparatus 1 includes information including the above-described impression information in the input information, similarly to the case of Step S3.

Furthermore, for example, instead of the information of the character string “Please select three or more images that the user who made the post . . . is determined to have had from the following values.”, the information processing apparatus 1 can also use information of the character string “Please determine a score indicating the degree of impression that the user who has made the post . . . has had for each of the following values. The score should be in the range of 1 to 10, and the higher the degree of impression, the larger the value.”, but is not limited to such an example.

Furthermore, the information processing apparatus 1 can determine the impression that the user U has had on the target information by limiting the attribute or the like of the user U from among the plurality of impressions IM1 to IMm included in the impression group using the generative AI. In this case, for example, instead of the information of the character string “Please select three or more images that the user who made the post . . . is determined to have had from the following values.”, the information processing apparatus 1 can also use information of “Please select three or more impressions that a twenties male who made the post . . . has had from the following values.” or information of the character string “Please determine, for each of the following values, the score indicating the degree of impression that a twenties male who has made the post . . . has had. The score should be in the range of 1 to 10, and the higher the degree of impression, the larger the value”. In a case where the generative AI is caused to determine one or more impressions IM that the user U having an attribute other than that of a twenties male has had, the information of the character string “twenties male” can be replaced with information indicating another attribute.

Furthermore, in a case where the user action information is image information, the information processing apparatus 1 can input information including the target information, instruction information including information of a character string “Please select three or more images that fit the input image from the following values.”, and the like, and impression information to the multimodal generative AI as input information, and also cause the multimodal generative AI to output the similarity. Note that the information processing apparatus 1 can limit the attribute or the like of the user U or output a score indicating the degree of the impression IM, as in a case where the target information is other than the image information.

Next, the second determination method will be described. The information processing apparatus 1 causes the generative AI to generate, for each impression IM included in the impression group, reference information on which the user U is determined to have had the impression IM, and compares such reference information with the user action information to determine one or more impressions IM that the user U has had on the specific target.

The information processing apparatus 1 generates, for each impression IM included in the impression group, information of the user U that the user U has had the impression as reference information. In a case where the impression group is an impression group by values based on Schwartz's value theory, the plurality of impressions IM classified by the impression group is the above-described 10 types of values or 56 types of values.

For example, the information processing apparatus 1 inputs, to the generative AI, input information including instruction information that is information for instructing generation of reference information on which the user U is determined to have had an impression indicated by the impression IM, and causes the generative AI to generate the reference information. The reference information is, for example, information indicated by at least one of a text or an image.

The information processing apparatus 1 stores fixed instruction information in advance, and inputs information including the fixed instruction information and the information of the impression IM to the generative AI as instruction information to cause the generative AI to generate the reference information for each impression IM. For example, in a case where the specific target is “car” and the user action information is review information for the specific target, the fixed instruction information is information of a character string “Post a certain value. Please create 10 reviews that Japanese users are likely to post about the values of the car. Please do not excessively include the posted value in the text”.

Furthermore, the information of the impression IM is, for example, information of a character string “value: social power”. Thus, each of the 10 reviews on which the user U is predicted to have the impression IM of social power is generated as the reference information.

After generating the reference information for each impression IM, the information processing apparatus 1 compares the user action information acquired in Step S2 with the reference information for each impression IM. The information processing apparatus 1 vectorizes the user action information and each piece of reference information in order to compare the user action information with the reference information for each impression IM.

The information is vectorized by, for example, embedding with a language model (for example, a transformer-based model). The vectorized information is represented by, for example, a vector of several hundred dimensions, but is not limited to such an example.

The embedding by the language model is, for example, embedding by text-embedding-ada, BERT, or the like provided by OpenAI, but is not limited to such an example.

Note that vectorization of information is not limited to embedding by a language model, and for example, vectorization of information may be performed by Doc2Vec, an average of word embedding, or the like. For word embedding, for example, Word2Vec, fastText, or the like is used.

For example, the information processing apparatus 1 classifies the user action information into the impression IM corresponding to the reference information in which the similarity of the vector to the user action information is equal to or more than a threshold. For example, the information processing apparatus 1 can classify the user action information into only one impression IM, or can classify the user action information into two or more impressions IM.

For example, the information processing apparatus 1 can classify the user action information into only one impression IM by classifying the user action information into the impression IM corresponding to the reference information in which the similarity of the vector is equal to or more than the threshold and in which the similarity is the highest.

Furthermore, in a case where the reference information in which the similarity of the vector to the user action information is equal to or more than the threshold is equal to or more than two, the information processing apparatus 1 can classify the user action information into two or more impressions IM respectively corresponding to the two or more pieces of reference information.

The similarity of the vector is cosine similarity, but may be Jaccard similarity or the like, or may be a reciprocal of a Euclidean distance, a reciprocal of a Manhattan distance, or the like. Furthermore, in a case of using the Euclidean distance or the Manhattan distance, the information processing apparatus 1 classifies, for example, the user action information whose Euclidean distance or Manhattan distance from the reference information is less than a threshold into the impression IM corresponding to the reference information.

Furthermore, the information processing apparatus 1 can learn a classification model by using a vector and corresponding hand-labeled data, and can classify similarity between vectors and the vector by any method such as classifying using the classification model, and further specify similarity between pieces of information or classify information.

Furthermore, in a case where the reference information and the user action information are images, the information processing apparatus 1 can input information including the reference information, the user action information, and instruction information indicating an instruction to output similarity between the reference information and the user action information to the multimodal generative AI as input information, and output the similarity from the multimodal generative AI.

In this case, for example, the information processing apparatus 1 classifies them into the impression IM corresponding to the reference information having the similarity generated by the multimodal generative AI equal to or more than the threshold and having the highest similarity, and the impression IM corresponding to the reference information having the similarity generated by the multimodal generative AI equal to or more than the threshold.

Furthermore, in a case where the reference information and the user action information are images, the information processing apparatus 1 can also cause the multimodal generative AI to generate an explanatory sentence that is a sentence describing what kind of image is included in each of the reference information and the user action information.

In this case, the information processing apparatus 1 vectorizes each of the explanatory sentence of the reference information and the explanatory sentence of the user action information, and calculates similarity between the vectorized reference information and the vectorized user action information. The method of calculating the similarity and the impression group of the user action information on an impression IM are similar to those in the case where the reference information and the user action information are texts.

Note that, in a case where the reference information and the user action information are images, the information processing apparatus 1 can also calculate the similarity by vectorizing each of the reference information and the user action information as it is.

Furthermore, in a case where the reference information and the user action information each include a text and an image, the information processing apparatus 1 classifies the user action information into the impression IM corresponding to the reference information in which the integrated score, which is a score obtained by weighting and adding the similarity between texts and the similarity between images, is equal to or more than a threshold and the impression IM corresponding to the reference information in which the integrated score is equal to or more than the threshold and is the largest.

Subsequently, the information processing apparatus 1 merges the estimation result in Step S3 and the determination result in Step S4 (Step S5). For example, as illustrated in FIG. 1, the information processing apparatus 1 generates merge information including the estimation result in Step S3 and the determination result in Step S4. The merge information includes specific target information and user target information.

The specific target information includes information indicating the type of the specific information, target information included in the improvement request received in Step S1, and the estimation result in Step S3. In the example illustrated in FIG. 1, information of the character string “text” is included as the information indicating the type of the specific information, information of the character string “The difference can be seen because it is used every day.” is included as the target information included in the improvement request received in Step S1, and information of the character string “free, independent, self-respect” is included as the estimation result in Step S3.

Furthermore, the user target information includes the type of the user action information acquired in Step S2, the user action information acquired in Step S2, and the determination result in Step S4. In the example illustrated in FIG. 1, information of the character string “review” is included as the information indicating the type of the user action information, information of the character string “It is easy to drive even for beginners!” is included as the user action information acquired in Step S2, and information of the character string “free, fun” is included as the determination result in Step S4.

Subsequently, the information processing apparatus 1 generates improvement information including information indicating improvement content related to the target information on the basis of the merge information obtained by the merge in Step S5 (Step S6). The information indicating improvement content related to the target information is target information after improvement, information indicating a method of providing the target information after improvement, or information indicating a method of improving the target information, but is not limited to such an example. The improvement information includes one or more pieces of information indicating the improvement content related to the target information.

For example, the information processing apparatus 1 generates a prompt, which is information to be input to the generative AI, on the basis of the information including supplementary information regarding merge information, the merge information, and the instruction information. For example, the information processing apparatus 1 generates a prompt including the supplementary information regarding merge information, the merge information, and the instruction information for causing the generative AI to output improvement information from the merge information. The information processing apparatus 1 inputs the generated prompt to the generative AI and causes the generative AI to output the improvement information, thereby generating the improvement information.

The supplementary information includes information indicating the specific target, information indicating the relationship between the estimation result in Step S3 and the determination result in Step S4, and the like. The supplementary information illustrated in FIG. 1 is information of a character string “There is the following gap between the text of the advertisement when model A of the compact car is launched and the user's values felt for model A of the compact car.”

The instruction information includes a character string based on the improvement directionality information included in the improvement request received in Step S1. For example, in a case where the improvement directionality indicated by the improvement directionality information is directionality of improvement to be closer to an impression that the user U is estimated to have, the instruction information includes information of a character string “Please consider a distribution condition to an advertisement target to change the user's values.”, but is not limited to such an example.

Furthermore, in a case where the improvement directionality indicated by the improvement directionality information is directionality of improvement to be closer to an impression that the user U is determined to have had, the instruction information includes information of a character string “Please change the text of the advertisement to an appropriate text to match the values that the user feels.”, but is not limited to such an example.

The instruction information illustrated in FIG. 1 is information of a character string “Since there is such a gap, please consider a distribution condition to an advertisement target to change the values of the user”. Note that the information input to the generative AI may include information of an advertisement target in addition to the above-described information.

Subsequently, the information processing apparatus 1 provides the operator O with the improvement information generated in Step S6 (Step S7). For example, the information processing apparatus 1 provides the operator O with the improvement information by transmitting the improvement information generated in Step S6 to the terminal device 3.

In this manner, the information processing apparatus 1 generates the improvement information including the information indicating the improvement content related to the target information on the basis of the target information including the information of the specific target, target impression information indicating the impression that the user U is estimated to have on the specific target, and user impression information indicating the impression that the user U is determined to have had on the target information. Thus, the information processing apparatus 1 can improve convenience on the provision side of the specific target.

Hereinafter, a configuration and the like of an information processing system including the information processing apparatus 1, a plurality of terminal devices 2, the terminal device 3, and the information processing apparatus 4 that perform such processing will be described in detail.

### 2. Configuration of Information Processing System

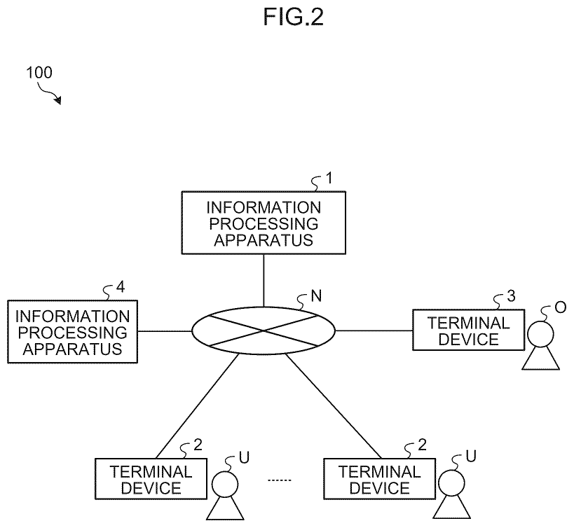

FIG. 2 is a diagram illustrating an example of a configuration of the information processing system according to the embodiment. As illustrated in FIG. 2, an information processing system 100 according to the embodiment includes the information processing apparatus 1, the plurality of terminal devices 2, the terminal device 3, and the information processing apparatus 4.

The plurality of terminal devices 2 is used by different users U, and the terminal device 3 is used by the operator O. The terminal devices 2 and 3 are, for example, a laptop personal computer (PC), a desktop PC, a smartphone, a tablet PC, and a wearable device. The wearable device is, for example, a smart glass, a smart watch, or the like, but is not limited to such an example.

The information processing apparatus 4 provides various types of information to the user U via the online site. The online site provided by the information processing apparatus 4 is, for example, an EC site, a news site, a Q & A site, a map site, an image posting site, a moving image browsing site, or the like, but is not limited to such an example.

Each of the information processing apparatus 1, the terminal device 2, the terminal device 3, and the information processing apparatus 4 is connected to communicate with each other in a wired or wireless manner via a network N. Note that the information processing system 100 illustrated in FIG. 2 may include a plurality of information processing apparatuses 1, a plurality of information processing apparatuses 4, and the like.

The network N includes, for example, a wide area network (WAN) such as the Internet and a mobile communication network such as long term evolution (LTE), the fourth generation (4G), or the fifth generation (5G).

The terminal devices 2 and 3 and the information processing apparatus 4 can be connected to the network N via short-range wireless communication such as a mobile communication network, Bluetooth (registered trademark), or a wireless local area network (LAN), and communicate with the information processing apparatus 1.

### 3. Configuration of Information Processing Apparatus 1

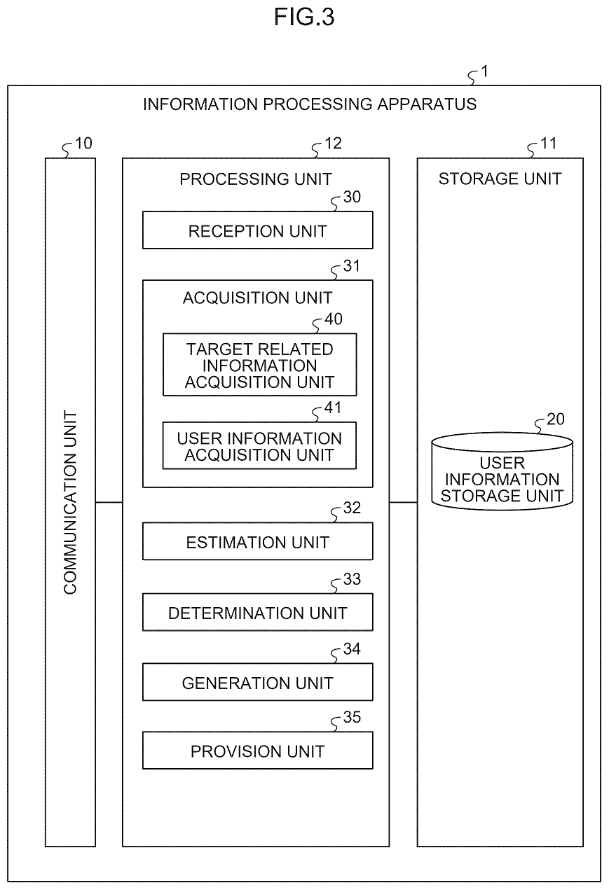

FIG. 3 is a diagram illustrating an example of a configuration of the information processing apparatus 1 according to the embodiment. As illustrated in FIG. 3, the information processing apparatus 1 includes a communication unit 10, a storage unit 11, and a processing unit 12.

### 3.1. Communication Unit 10

The communication unit 10 is implemented by, for example, a communication module, a network interface card (NIC), or the like. Then, the communication unit 10 is connected to the network N in a wired or wireless manner, and transmits and receives information to and from various other devices. For example, the communication unit 10 transmits and receives information to and from each of the terminal device 2, the terminal device 3, and the information processing apparatus 4 via the network N.

### 3.2. Storage Unit 11

The storage unit 11 is implemented by, for example, a semiconductor memory element such as a random access memory (RAM) or a flash memory, or a storage device such as a hard disk or an optical disk. The storage unit 11 includes a user information storage unit 20.

### 3.2.1. User Information Storage Unit 20

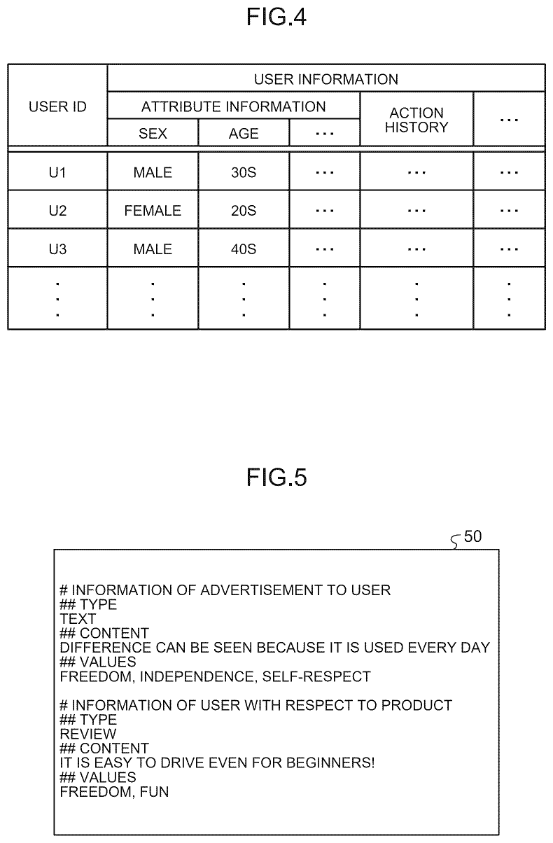

The user information storage unit 20 stores user information including information regarding the user U. FIG. 4 is a diagram illustrating an example of a user information table stored in the user information storage unit 20 of the information processing apparatus 1 according to the embodiment. As illustrated in FIG. 4, the user information table stored in the user information storage unit 20 includes items such as “user ID” and “user information”.

The “user ID” is identification information for identifying the user U. The “user information” is information of the user U corresponding to the “user ID”, and includes items such as “attribute information” and “action history”.

The “attribute information” is attribute information of the user U corresponding to the “user ID”, and includes, for example, information of a psychographic attribute, information of a demographic attribute, and the like. The demographic attribute is, for example, sex, age, place of residence, occupation, and the like, and the psychographic attribute is a target of interest such as travel, clothes, cars, and Religion, a lifestyle, an idea, a tendency of an idea, or the like.

The “action history” includes information of an action history of the user U associated with the “user ID”. The action history of the user U includes, for example, information of a movement history of the user U and information of an action history of the user U in the online service. The information of the movement history by the user U includes, for example, information of a route traveled by the user U, information of a place visited by the user U, and the like.

The information of the action history of the user U in the online service includes information indicating the action of the user U related to a specific target whose content is provided by the information processing apparatus 4 in the online site.

The action of the user U related to the specific target may include, for example, posting of a review for the specific target, an answer to a questionnaire for the specific target by the user U, an evaluation (for example, a positive evaluation, a negative evaluation, a degree thereof, or the like) action for the specific target posted by the user U, a browsing action for a web page of the specific target by the user U, a search action for the specific target by the user U, and the like. Furthermore, the action related to the specific target may be a comment on the specific target on the SNS. The review for the specific target, the comment for the specific target on the SNS, the evaluation for the specific target posted by the user U, and the like are examples of the posted message.

Furthermore, the information of the action history of the user U in the online service includes, for example, a search history, an access history, a post history, and the like of the user U in the online service. The search history of the user U includes, for example, a search history of content by the user U in a web search service. The access history of the user U is, for example, an access history of content by the user U in the online service, and includes information of content of various sites accessed by the user U.

### 3.3. Processing Unit 12

The processing unit 12 is a controller, and is implemented by, for example, a processor such as a central processing unit (CPU) or a micro processing unit (MPU) executing various programs (corresponding to an example of an information processing program) stored in a storage device inside the information processing apparatus 1 using a RAM or the like as a work area.

Furthermore, the processing unit 12 is a controller, and may be implemented by, for example, an integrated circuit such as an application specific integrated circuit (ASIC), a field programmable gate array (FPGA), or a general purpose graphic processing unit (GPGPU).

As illustrated in FIG. 3, the processing unit 12 includes a reception unit 30, an acquisition unit 31, an estimation unit 32, a determination unit 33, a generation unit 34, and a provision unit 35, and implements or executes a function and an action of information processing described below. Note that an internal configuration of the processing unit 12 is not limited to the configuration illustrated in FIG. 3, and may be another configuration as long as it is a configuration that performs information processing to be described later.

### 3.3.1. Reception Unit 30

The reception unit 30 receives various types of information and requests from the terminal device 2 and the terminal device 3 via the network N and the communication unit 10.

For example, the reception unit 30 receives an improvement request transmitted from the terminal device 3 of the operator O who creates or provides target information that is information of a specific target. The improvement request includes, for example, target information including information of the specific target, improvement directionality information indicating directionality of improvement of the target information, and user specifying information that is information for specifying the target user U. The reception unit 30 receives the target information, the improvement directionality information, and the user specifying information by receiving the improvement request.

The specific target is, for example, a product, a service, or the like, but may be an organization such as a company, a facility such as a school or a hospital, a local government such as a city, a town, or a village, or the like, or may be other targets. Specific information is an advertisement or the like for advertising the specific target, and is, for example, a catch phrase, a package, an explanatory sentence, an introductory sentence, or the like of the specific target, but is not limited to such an example. For example, in a case where the specific target is moving image content or music content, the information of the specific target may be moving image content itself or music content itself.

The directionality of improvement of the target information is, for example, directionality of improvement to be closer to an impression that the user U is estimated to have and directionality of improvement to be closer to an impression that the user U is determined to have had, but is not limited to such an example.

For example, the directionality of improvement of the target information may be an intermediate directionality of improvement between the impression that the user U is estimated to have and the impression that the user U is determined to have had, may be directionality of improvement indicating the degree of closeness (for example, 70% close) to the impression that the user U is estimated to have, or may be directionality of improvement indicating the degree of closeness (for example, 80% close) to the impression that the user U is determined to have had.

The user specifying information is information for specifying the target user U. The target user U is a user U to whom the target information is provided, but is not limited to such an example and may be, for example, a user U to whom the target information is provided and who has purchased or used the specific target. Furthermore, the target user U may be the user U to whom the target information is provided. The user specifying information is, for example, information indicating an attribute of the target user U, information indicating an action of the target user U that is an action of the user U related to the specific target, or the like, but is not limited to such an example.

The action of the user U related to the specific target is, for example, a review for the specific target and an answer to a questionnaire for the specific target by the user U, but is not limited to such an example. Furthermore, the action related to the specific target may include an evaluation (for example, a positive evaluation, a negative evaluation, a degree thereof, or the like) action on the specific target posted by the user U, a browsing action on a web page of the specific target by the user U, a search action for the specific target by the user U, and the like. Furthermore, the action related to the specific target may be a comment on the specific target on the SNS.

Furthermore, the improvement request may include estimation method type information indicating a type of a method for estimating an impression that the user U has for the specific target. There is a plurality of estimation methods including a first estimation method and a second estimation method as the type of the method for estimating an impression that the user U has on the specific target. The reception unit 30 receives the estimation method type information by receiving the improvement request.

The first estimation method is a method of causing the generative AI to directly estimate the impression that the user U has on the specific target. The second estimation method is a method for causing the generative AI to generate, for each impression included in an impression group, reference content on which the user U is estimated to have the impression, and comparing such reference content with the target content to estimate an impression that the user U has on the target content.

Furthermore, the improvement request may include determination method type information indicating the type of the determination method of the impression that the user U has had on the specific target. There is a plurality of determination methods including a first determination method and a second determination method as the type of the method for determining an impression that the user U has had on the specific target. A reception unit 30 receives the determination method type information by receiving the improvement request.

The first determination method is a method of causing the generative AI to directly determine the impression that the user U has had on the specific target. The second estimation method is a method for causing the generative AI to generate, for each impression included in the impression group, reference content on which the user U is determined to have had the impression, and comparing such reference content with the target content to determine the impression that the user U has had on the target content.

### 3.3.2. Acquisition Unit 31

The acquisition unit 31 acquires various types of information from the information processing apparatus 4 and the storage unit 11. For example, the acquisition unit 31 acquires various kinds of content and information of each user U from the information processing apparatus 4 via the network N and the communication unit 10. In addition, the acquisition unit 31 acquires information of each user U from the user information storage unit 20 of the storage unit 11.

The acquisition unit 31 includes a target related information acquisition unit 40 that acquires target information including information of a specific target and target impression information indicating an impression that the user U is estimated to have on the specific target, and a user information acquisition unit 41 that acquires user impression information indicating an impression that the user U is determined to have had on the target information. As described above, the specific target is, for example, a product, a service, or the like. As described above, the specific information is an advertisement for advertising the specific target, and is, for example, a catch phrase, a package, an explanatory sentence, an introductory sentence, or the like of the specific target, but is not limited to such an example.

### 3.3.2.1. Target Related Information Acquisition Unit 40

The target related information acquisition unit 40 acquires the target information, the improvement directionality information, and the user specifying information included in the improvement request received by the reception unit 30.

Furthermore, in a case where the improvement request received by the reception unit 30 includes the estimation method type information, the target related information acquisition unit 40 acquires the estimation method type information included in the improvement request.

Furthermore, the target related information acquisition unit 40 acquires, from the estimation unit 32, target impression information indicating the impression that the user U is estimated to have on the specific target by the estimation unit 32. In addition, in a case where the target impression information is stored in the storage unit 11 by the estimation unit 32, the target related information acquisition unit 40 acquires the target impression information from the storage unit 11.

### 3.3.2.2. User Information Acquisition Unit 41

The user information acquisition unit 41 acquires the user action information from the information processing apparatus 4 or the storage unit 11 on the basis of the user specifying information included in the improvement request received by the reception unit 30.

The user action information is information of the user U specified by the user specifying information, and is information indicating an action of the user U regarding content provided on the online site provided by the information processing apparatus 4. The content of the specific target provided on the online site provided by the information processing apparatus 4 includes content for the user U to perform an action related to the specific target described above, and is, for example, content including content for posting a review for the specific target, content including content for answering a questionnaire for the specific target, or the like, but is not limited to such an example.

The content of the specific target includes the specific information, but is not limited to such an example, and need not include the specific information. The target information is an advertisement including one or more of a package of a specific target, a catch phrase of the specific target, an explanatory sentence of the specific target, and an introductory sentence of the specific target, but is not limited to such an example. For example, in a case where the specific target is content, the specific information may be information of the content itself.

The action of the user U indicated by the user action information is, for example, a review for the specific target, an answer to a questionnaire for the specific target by the user U, an evaluation (for example, a positive evaluation, a negative evaluation, a degree thereof, or the like) action for the specific target posted by the user U, a browsing action for a web page of the specific target by the user U, a search action for the specific target by the user U, a comment for the specific target on the SNS, and the like as described above, but is not limited to such an example.

Furthermore, the user information acquisition unit 41 acquires, from the determination unit 33, user impression information indicating an impression that the user U is determined to have had on the target information by the determination unit 33. Furthermore, in a case where the user impression information is stored in the storage unit 11 by the determination unit 33, the user information acquisition unit 41 acquires the user impression information from the storage unit 11.

### 3.3.3. Estimation Unit 32

The estimation unit 32 performs various estimations. The estimation unit 32 estimates an impression that the user U is estimated to have on the basis of the target information. For example, the estimation unit 32 estimates an impression that the user U is estimated to have on the basis of the target information acquired by the target related information acquisition unit 40.

In a case where the improvement request received by the reception unit 30 includes the estimation method type information, the estimation unit 32 estimates the impression of the user U by the type estimation method indicated by the estimation method type information. In a case where the improvement request received by the reception unit 30 does not include the estimation method type information, the information processing apparatus 1 estimates the impression of the user U by the first estimation method. The generative AI is arranged in an external information processing apparatus, and the estimation unit 32 uses the generative AI via an API, but the generative AI may be arranged in the information processing apparatus 1.

First, the first estimation method will be described. The estimation unit 32 estimates, using the generative AI, the impression that the user U has of the specific target from among the plurality of impressions IM1 to IMm included in the impression group on the basis of the target information included in the improvement request received by the reception unit 30.

The impressions IM1 to IMm are values based on Schwartz's value theory, but are not limited to such examples. For example, the impressions IM1 to IMm may be values classified by traditionalism, success intention, self-realization intention, symbiotic intention, or the like, or may be other values. Furthermore, the impressions IM1 to IMm may be classified into, for example, five dimensions of honesty, irritation, ability, refinement, and masculinity, or further subdivided ones thereof, or may be classified on the basis of functional benefits such as performance, quality, and convenience, and emotional benefits such as joy, satisfaction, and reassurance.

Furthermore, the impressions IM1 to IMm may be classified into, for example, four dimensions of quality, emotion, price, and social value, or further subdivided, or may be impressions classified by other classification methods. In addition, the impressions IM1 to IMm may be impressions set in advance for each type of the specific target.

First, the estimation unit 32 causes the generative AI to estimate the impression IM that the user U has on the specific target from among the plurality of impressions IM1 to IMm included in the impression group. For example, the information processing apparatus 1 inputs information including instruction information for instructing selection of the impression IM that the user U has on the specific target from among the plurality of impressions IM1 to IMm indicated by the impression information, the impression information indicating the plurality of impressions IM1 to IMm included in the impression group, and the target information to the generative AI as input information, and outputs information indicating one or more impressions IM that the user U is estimated to have on the specific target from the generative AI.

For example, it is assumed that the impression group is an impression group that gives an impression of the values of the user U, and the target information is a sales copy “The difference can be seen because it is used every day”. In this case, the information processing apparatus 1 includes, for example, information of a character string “Please select three or more images that fit the sales copy ‘The difference can be seen because it is used every day.’ from the following values. ¥nValue, Reason” in the input information as the instruction information. In this manner, the instruction information includes the target information included in the improvement request received by the reception unit 30.

Furthermore, the estimation unit 32 includes information including information of a character string “Social power, authority, riches, saving honor, social approval ¥nsuccess, competence, ambition, influence, intelligence ¥nfun, enjoyment of life ¥nbravery, life of change, lively life ¥ncreativity, curiousness, freedom, goal choice, self-respect, independence ¥nenvironmental protection, world of beauty, harmony with nature, generosity, social fairness, intelligence, equality, world peace, inner harmony ¥nassistance, honesty, tolerance, loyalty, responsibility, true friendship, spiritual world, mature love, meaning of life, ¥npoliteness, respect to parents and elders, self discipline, obedience, ¥npiety, acceptance of fate, humility, moderation, respect for tradition, supernatural ¥ncleanliness, national security, social order, household safety, returning a favor, health, belonging feeling” as the impression information in the input information.

Furthermore, for example, instead of the information of the character string “Please select three or more images that fit the sales copy . . . from the following values.”, the estimation unit 32 can also use information of “Please select three or more of the following values for the impression that the user is estimated to have on the sales copy . . . ” or information of a character string “Please estimate a score indicating the degree of impression that the user is estimated to have on the sales copy . . . for each of the following values. The score should be in the range of 1 to 10, and the higher the degree of impression, the larger the value.”, but is not limited to such an example.

Furthermore, the estimation unit 32 can also estimate the impression that the user U has on the target information by limiting the attribute of the user U and the like from among the plurality of impressions IM1 to IMm included in the impression group using the generative AI. In this case, for example, instead of the information of the character string “Please select three or more images that fit the sales copy . . . from the following values.”, the estimation unit 32 can also use the information of “Please select three or more of the following values for the impression that a twenties male is estimated to have on the sales copy . . . ” or information of a character string “Please estimate a score indicating the degree of impression that a twenties male is estimated to have on the sales copy . . . for each of the following values. The score should be in the range of 1 to 10, and the higher the degree of impression, the larger the value”. In a case where the generative AI is caused to estimate one or more impressions IM that the user U having an attribute other than twenties male has, the information of the character string “twenties male” can be replaced with information indicating another attribute.

Furthermore, in a case where the target information is image information, the estimation unit 32 can input information including the target information, instruction information including information of a character string “Please select three or more images that fit the input image from the following values.”, and the like, and impression information to the multimodal generative AI as input information, and also cause the multimodal generative AI to output the similarity. Note that the information processing apparatus 1 can limit the attribute or the like of the user U or output a score indicating the degree of the impression IM, as in a case where the target information is other than the image information.

Furthermore, the estimation unit 32 can also estimate the degree of the impression that the user U is estimated to have for each impression, using the generative AI. For example, by inputting instruction information including information of a character string “Please estimate the percentage of each value that the input sales copy gives to the user.” or the like to the generative AI, the degree of the impression that the user U is estimated to have is estimated for each impression.

Next, the second estimation method will be described. The estimation unit 32 causes the generative AI to generate reference information on which the user U is estimated to have the impression IM for each impression IM included in the impression group, and compares the reference information with the target information to estimate one or more impressions IM that the user U has on the target information.

The estimation unit 32 generates, for each impression IM included in the impression group, reference information on which the user U is estimated to have the impression. In a case where the impression group is an impression group by values based on Schwartz's value theory, the plurality of impressions IM classified by the impression group is the above-described 10 types of values or 56 types of values.

For example, the estimation unit 32 inputs, to the generative AI, input information including instruction information that is information for instructing generation of reference information on which the user U is estimated to have the impression indicated by the impression IM, and causes the generative AI to generate the reference information. The reference information is, for example, information indicated by at least one of a text or an image.

The estimation unit 32 stores fixed instruction information in advance, and inputs information including the fixed instruction information and the information of the impression IM to the generative AI as instruction information to cause the generative AI to generate the reference information for each impression IM. For example, in a case where the specific target is “car” and the target information is a sales copy for the specific target, the fixed instruction information is information of a character string “Post a certain value. Please make 10 sales copies that Japanese users are likely to have the value for the car. Please do not excessively include the posted value in the text”.

Furthermore, the information of the impression IM is, for example, information of a character string “value: social power”. Thus, each of the 10 sales copies on which the user U is predicted to have the impression IM of social power is generated as the reference information.

After generating the reference information for each impression IM, the estimation unit 32 compares target information to be estimated of the impression IM that the user U has with the reference information for each impression IM. The estimation unit 32 vectorizes the target information and each piece of reference information in order to compare the target information with the reference information for each impression IM.

The information is vectorized by, for example, embedding with a language model (for example, a transformer-based model). The vectorized information is represented by, for example, a vector of several hundred dimensions, but is not limited to such an example.

The embedding by the language model is, for example, embedding by text-embedding-ada, BERT, or the like provided by OpenAI, but is not limited to such an example.

Note that vectorization of information is not limited to embedding by a language model, and for example, vectorization of information may be performed by Doc2Vec, an average of word embedding, or the like. For word embedding, for example, Word2Vec, fastText, or the like is used.

For example, the estimation unit 32 classifies the target information into the impression IM corresponding to the reference information in which the similarity of the vector to the target information is equal to or more than a threshold. For example, the estimation unit 32 can classify the target information into only one impression IM, or can classify the target information into two or more impressions IM.

For example, the estimation unit 32 can classify the target information into only one impression IM by classifying the target information into the impression IM corresponding to the reference information in which the similarity of the vector is equal to or more than the threshold and in which the similarity is the highest.

Furthermore, in a case where the reference information in which the similarity of the vector to the target information is equal to or more than the threshold is equal to or more than 2, the estimation unit 32 can classify the target information into two or more impressions IM respectively corresponding to the two or more pieces of reference information.

The similarity of the vector is cosine similarity, but may be Jaccard similarity or the like, or may be a reciprocal of a Euclidean distance, a reciprocal of a Manhattan distance, or the like. Furthermore, in a case of using the Euclidean distance or the Manhattan distance, the estimation unit 32 classifies, for example, target information whose Euclidean distance or Manhattan distance from the reference information is less than a threshold into the impression IM corresponding to the reference information.

Furthermore, the estimation unit 32 can learn a classification model by using a vector and corresponding hand-labeled data, and can classify similarity between vectors and the vector by any method such as classifying using the classification model, and further specify similarity between pieces of information or classify information.

Furthermore, in a case where the reference information and the target information are images, the estimation unit 32 can also input information including the reference information, the target information, and instruction information indicating an instruction to output similarity between the reference information and the target information to the multimodal generative AI as input information, and output the similarity from the multimodal generative AI.

In this case, for example, the estimation unit 32 classifies them into the impression IM corresponding to the reference information having the similarity generated by the multimodal generative AI equal to or more than the threshold and having the highest similarity, and the impression IM corresponding to the reference information having the similarity generated by the multimodal generative AI equal to or more than the threshold.

Furthermore, in a case where the reference information and the target information are images, the estimation unit 32 can also cause the multimodal generative AI to generate an explanatory sentence that is a sentence describing what kind of image is included in each of the reference information and the target information.

In this case, the estimation unit 32 vectorizes each of an explanatory sentence of the reference information and an explanatory sentence of the target information, and calculates similarity between the vectorized reference information and the vectorized target information. A method of calculating the similarity and a method of classifying the target information into the impression IM are similar to those in the case where the reference information and the target information are texts.

Note that, in a case where the reference information and the target information are images, the estimation unit 32 can also calculate the similarity by vectorizing each of the reference information and the target information as it is.

In addition, in a case where the reference information and the target information each include a text and an image, the estimation unit 32 classifies them into the impression IM corresponding to the reference information in which an integrated score, which is a score obtained by weighting and adding the similarity between texts and the similarity between images, is equal to or more than a threshold, and the impression IM corresponding to the reference information in which the integrated score is equal to or more than the threshold and is the largest.

Furthermore, the estimation unit 32 can also estimate the similarity and the total score described above as the degree of impression that the user U is estimated to have.

### 3.3.4. Determination Unit 33

The determination unit 33 determines the impression that the user U has had on the basis of the information of the user U regarding the specific target on the basis of the target information. For example, the determination unit 33 determines an impression that the user U is estimated to have had on the basis of the user action information acquired by the user information acquisition unit 41.

As described above, the user action information is information of the user U specified by the user specifying information, and is information indicating an action of the user U related to the specific target provided with content (for example, content such as an introduction page or a purchase page of the specific target) on the online site provided by the information processing apparatus 4.

The user action information is, for example, a posted message of the user U with respect to the specific target, and the determination unit 33 determines the impression that the user U has had on the basis of the posted message of the user U with respect to the specific target. The posted message is, for example, a review for the specific target, a comment for the specific target on the SNS, an evaluation for the specific target posted by the user U, or the like, but is not limited to such an example.

In a case where the improvement request received by the reception unit 30 includes the determination method type information, the determination unit 33 determines the impression that the user U has had by the type determination method indicated by the determination method type information. In a case where the determination method type information is not included in the improvement request received by the reception unit 30, the determination unit 33 determines the impression that the user U has had by the first determination method.

First, the first determination method will be described. The determination unit 33 determines the impression that the user U has had on the specific target from among the plurality of impressions IM1 to IMm included in the impression group using the generative AI.

The determination unit 33 determines the impression that the user U has had on the specific target from among a plurality of impressions included in the impression group using the generative AI on the basis of the user action information acquired in Step S2. First, the determination unit 33 causes the generative AI to determine the impression IM that the user U has had on the specific target from among the plurality of impressions IM1 to IMm included in the impression group.

For example, the determination unit 33 inputs information including instruction information for instructing selection of the impression IM that the user U has had on the specific target from among the plurality of impressions IM1 to IMm indicated by the impression information, the impression information indicating the plurality of impressions IM1 to IMm included in the impression group, and the user action information acquired in Step S2 to the generative AI as input information, and outputs information indicating one or more impressions IM that the user U is estimated to have had on the specific target from the generative AI.

For example, it is assumed that the impression group is an impression group that gives an impression of the values of the user U, the target information is a sales copy “The difference can be seen because it is used every day.”, and the user action information is a review (an example of a posted message) of “It is easy to drive even for beginners!”. In this case, for example, the determination unit 33 includes information of a character string “Please select three or more images that the user who made the post ‘It is easy to drive even for beginners!’ with respect to a certain target is determined to have had on the target from the following values. ¥nValue, Reason” in the input information as the instruction information. In this manner, the instruction information includes the user action information acquired in Step S2.

In addition, the determination unit 33 includes information including the above-described impression information in the input information, similarly to the case of the estimation processing by the estimation unit 32.

Furthermore, for example, instead of the information of the character string “Please select three or more images that the user who made the post . . . is determined to have had from the following values.”, the determination unit 33 can use information of the character string “Please determine a score indicating a degree of impression that the user who has made the post . . . has had for each of the following values. The score should be in the range of 1 to 10, and the higher the degree of impression, the larger the value.”, but is not limited to such an example.

Furthermore, the determination unit 33 can limit the attribute of the user U and the like and determine the impression that the user U has had on the target information from among the plurality of impressions IM1 to IMm included in the impression group using the generative AI. In this case, for example, instead of the information of the character string “Please select three or more images that the user who made the post . . . is determined to have had from the following values.”, the determination unit 33 can use information of “Please select three or more impressions that a twenties male who made the post . . . has had from the following values.” or information of the character string “Please determine, for each of the following values, the score indicating the degree of impression that a twenties male who has made the post . . . has had. The score should be in the range of 1 to 10, and the higher the degree of impression, the larger the value”. In a case where the generative AI is caused to determine one or more impressions IM that the user U having an attribute other than that of a twenties male has had, the information of the character string “twenties male” can be replaced with information indicating another attribute.

Furthermore, in a case where the user action information is image information, the determination unit 33 can input information including the target information, instruction information including information of a character string “Please select three or more images that fit the input image from the following values.”, and the like, and impression information to the multimodal generative AI as input information, and also cause the multimodal generative AI to output the similarity. Note that the determination unit 33 can limit the attribute or the like of the user U or output a score indicating the degree of the impression IM, similarly to the case where the target information is other than the image information.

Furthermore, the determination unit 33 can also determine the degree of impression that the user U is determined to have had for each impression, using the generative AI. For example, by inputting instruction information including information of a character string “Please determine the percentage of each value that the input sales copy gives to the user.” or the like to the generative AI, the degree of impression that the user U is determined to have had is determined for each impression.

Next, the second determination method will be described. The determination unit 33 causes the generative AI to generate, for each impression IM included in the impression group, reference information on which the user U is determined to have had the impression IM, and compares such reference information with the user action information to determine one or more impressions IM that the user U has had on the specific target.

The determination unit 33 generates, for each impression IM included in the impression group, information of the user U that the user U has had the impression as reference information. In a case where the impression group is an impression group by values based on Schwartz's value theory, the plurality of impressions IM classified by the impression group is the above-described 10 types of values or 56 types of values.

For example, the determination unit 33 inputs, to the generative AI, input information including instruction information that is information for instructing generation of reference information on which the user U is determined to have had an impression indicated by the impression IM, and causes the generative AI to generate the reference information. The reference information is, for example, information indicated by at least one of a text or an image.

The determination unit 33 stores fixed instruction information in advance, and inputs information including the fixed instruction information and the information of the impression IM to the generative AI as instruction information to cause the generative AI to generate the reference information for each impression IM. For example, in a case where the specific target is “car” and the user action information is review information for the specific target, the fixed instruction information is information of a character string “Post a certain value. Please create 10 reviews that Japanese users are likely to post about the values of the car. Please do not excessively include the posted value in the text”.

Furthermore, the information of the impression IM is, for example, information of a character string “value: social power”. Thus, each of the 10 reviews on which the user U is predicted to have the impression IM of social power is generated as the reference information.

After generating the reference information for each impression IM, the determination unit 33 compares the user action information acquired by the acquisition unit 31 with the reference information for each impression IM. The determination unit 33 vectorizes the user action information and each piece of reference information in order to compare the user action information with the reference information for each impression IM.

The information is vectorized by, for example, embedding with a language model (for example, a transformer-based model). The vectorized information is represented by, for example, a vector of several hundred dimensions, but is not limited to such an example.

The embedding by the language model is, for example, embedding by text-embedding-ada, BERT, or the like provided by OpenAI, but is not limited to such an example.

Note that vectorization of information is not limited to embedding by a language model, and for example, vectorization of information may be performed by Doc2Vec, an average of word embedding, or the like. For word embedding, for example, Word2Vec, fastText, or the like is used.

For example, the determination unit 33 classifies the user action information into the impression IM corresponding to the reference information in which the similarity of the vector to the user action information is equal to or more than a threshold. For example, the determination unit 33 can classify the user action information into only one impression IM, or can classify the user action information into two or more impressions IM.

For example, the determination unit 33 can classify the user action information into only one impression IM by classifying the user action information into the impression IM corresponding to the reference information in which the similarity of the vector is equal to or more than the threshold and in which the similarity is the highest.

Furthermore, in a case where the reference information in which the similarity of the vector to the user action information is equal to or more than the threshold is equal to or more than two, the determination unit 33 can classify the user action information into two or more impressions IM respectively corresponding to the two or more pieces of reference information.

The similarity of the vector is cosine similarity, but may be Jaccard similarity or the like, or may be a reciprocal of a Euclidean distance, a reciprocal of a Manhattan distance, or the like. Furthermore, in a case of using the Euclidean distance or the Manhattan distance, the determination unit 33 classifies, for example, the user action information whose Euclidean distance or Manhattan distance from the reference information is less than a threshold into the impression IM corresponding to the reference information.

Furthermore, the determination unit 33 can learn a classification model by using a vector and corresponding hand-labeled data, and can classify similarity between vectors and the vector by any method such as classifying using the classification model, and further specify similarity between pieces of information or classify information.

Furthermore, in a case where the reference information and the user action information are images, the determination unit 33 can input information including the reference information, the user action information, and instruction information indicating an instruction to output similarity between the reference information and the user action information to the multimodal generative AI as input information, and output the similarity from the multimodal generative AI.

In this case, for example, the determination unit 33 classifies them into the impression IM corresponding to the reference information having the similarity generated by the multimodal generative AI equal to or more than the threshold and having the highest similarity, and the impression IM corresponding to the reference information having the similarity generated by the multimodal generative AI equal to or more than the threshold.

Furthermore, in a case where the reference information and the user action information are images, the determination unit 33 can also cause the multimodal generative AI to generate an explanatory sentence that is a sentence describing what kind of image is included in each of the reference information and the user action information.

In this case, the determination unit 33 vectorizes each of the explanatory sentence of the reference information and the explanatory sentence of the user action information, and calculates similarity between the vectorized reference information and the vectorized user action information. The method of calculating the similarity and the impression group of the user action information on an impression IM are similar to those in the case where the reference information and the user action information are texts.

Note that, in a case where the reference information and the user action information are images, the determination unit 33 can also calculate the similarity by vectorizing each of the reference information and the user action information as it is.

Furthermore, in a case where the reference information and the user action information each include a text and an image, the determination unit 33 classifies the user action information into the impression IM corresponding to the reference information in which the integrated score, which is a score obtained by weighting and adding the similarity between texts and the similarity between images, is equal to or more than a threshold and the impression IM corresponding to the reference information in which the integrated score is equal to or more than the threshold and is the largest.

Furthermore, the determination unit 33 can also determine the similarity and the total score as the degree of impression that the user U is determined to have had.

### 3.3.5. Generation Unit 34

The generation unit 34 generates improvement information including information indicating improvement content related to the target information on the basis of the target information and the target impression information acquired by the target related information acquisition unit 40 and the user impression information acquired by the user information acquisition unit 41. The generation unit 34 generates the improvement information using, for example, the generative AI.

As described above, the target information is information of the specific target. As described above, the target impression information is information indicating the impression that the user U is estimated to have on the specific target by the estimation unit 32. The user impression information is information indicating an impression that the user U is determined to have had on the target information by the determination unit 33.

Furthermore, the generation unit 34 can generate the improvement information on the basis of information further including improvement directionality information received by the reception unit 30 in addition to the target information, the target impression information, and the user impression information.

For example, the generation unit 34 generates merge information obtained by merging the target information, the target impression information, the user impression information, and the like, and generates a prompt to be input to the generative AI on the basis of the generated merge information. Then, the generation unit 34 inputs the generated prompt to the generative AI as input information, and causes the generative AI to output the improvement information. Hereinafter, processing of the generation unit 34 will be specifically described.

The generation unit 34 merges the estimation result by the estimation unit 32 with the determination result by the determination unit 33. The merge information includes, for example, specific target information and user target information.

The specific target information includes information indicating the type of the specific information, target information included in the improvement request received by the reception unit 30, and target impression information that is an estimation result by the estimation unit 32. Furthermore, the user target information includes the type of the user action information acquired by the acquisition unit 31, the user action information acquired by the acquisition unit 31, and the user target information that is the determination result by the determination unit 33.

FIG. 5 is a diagram illustrating an example of merge information generated by the generation unit 34 in the processing unit 12 of the information processing apparatus 1 according to the embodiment. In the merge information 50 illustrated in FIG. 5, information of the character string “text” is included as the information indicating the type of the specific information, information of the character string “The difference can be seen because it is used every day.” is included as the target information included in the improvement request received by the reception unit 30, and information of the character string “free, independent, self-respect” is included as the estimation result by the estimation unit 32.

Furthermore, in the merge information 50, information of the character string “review” is included as the information indicating the type of the user action information, information of the character string “It is easy to drive even for beginners!” is included as the user action information acquired by the acquisition unit 31, and information of the character string “free, fun” is included as the determination result by the determination unit 33.

The generation unit 34 generates improvement information including information indicating improvement content related to the target information on the basis of the generated merge information. The information indicating improvement content related to the target information is target information after improvement, information indicating a method of providing the target information after improvement, or information indicating a method of improving the target information, but is not limited to such an example. The improvement information includes one or more pieces of information indicating the improvement content related to the target information.

The target information after improvement is, for example, a text advertisement after improvement in a case where the target information is a text advertisement, a picture advertisement after improvement in a case where the target information is a picture advertisement, and an advertisement including at least one piece of information after improvement of a text and an image in a case where the target information is an advertisement including a text and an image. The target information after improvement is, for example, moving image content after improvement in a case where the target information is moving image content, and is music content after improvement in a case where the target information is music content.

For example, in a case where the target information is an advertisement, the method of providing the target information is a keyword of a sponsored search, a distribution condition to an advertisement target, a condition of a target user, a site traffic line, and the like, but is not limited to such an example. For example, in a case where the target information is moving image content or music content, the method of providing the target information is an attribute condition of the user as a recommendation target, or the like.

For example, the information indicating the method of improving the target information is, for example, information indicating a font, a size, highlight display, arrangement, and the like of the text in a case where the target information is a text advertisement, and is, for example, information indicating a size, arrangement, and the like of an image in a case where the target information is an image advertisement. Furthermore, in a case where the target information is an advertisement including a text and an image, the information indicating the method of improving the target information is information indicating a font, a size, highlight display, and arrangement of the text, and a size, arrangement, and the like of an image.

Furthermore, in a case where the target information is moving image content, the information indicating the method of improving the target information is information indicating a scenario, a script, casting, and the like after improvement. In addition, in a case where the target information is music content, the information indicating the method of improving the target information is information indicating a method of improving lyrics, information indicating arrangement or selection of music components after improvement, or the like, but is not limited to such an example.

For example, the generation unit 34 generates a prompt, which is information to be input to the generative AI, on the basis of the information including supplementary information regarding the merge information, the merge information, and the instruction information. For example, the generation unit 34 generates a prompt including the supplementary information regarding merge information, the merge information, and the instruction information for causing the generative AI to output the improvement information from the merge information. The generation unit 34 inputs the generated prompt to the generative AI and causes the generative AI to output the improvement information, thereby generating the improvement information.

The supplementary information includes information indicating the specific target, information indicating the relationship between the estimation result by the estimation unit 32 and the determination result by the determination unit 33, and the like.

The instruction information includes a character string based on the improvement directionality information included in the improvement request received by the reception unit 30. For example, in a case where the improvement directionality indicated by the improvement directionality information is directionality of improvement to be closer to an impression that the user U is estimated to have, the instruction information includes information of a character string “Please consider a distribution condition to an advertisement target to change the user's values.”, but is not limited to such an example.

Furthermore, in a case where the improvement directionality indicated by the improvement directionality information is directionality of improvement to be closer to an impression that the user U is determined to have had, the instruction information includes information of a character string “Please change the text of the advertisement to an appropriate text to match the values that the user feels.”, but is not limited to such an example.

The generation unit 34 has template information that is information to be a template for each improvement directionality indicated by the improvement directionality information, and can generate a prompt using the template information corresponding to the improvement directionality indicated by the improvement directionality information.

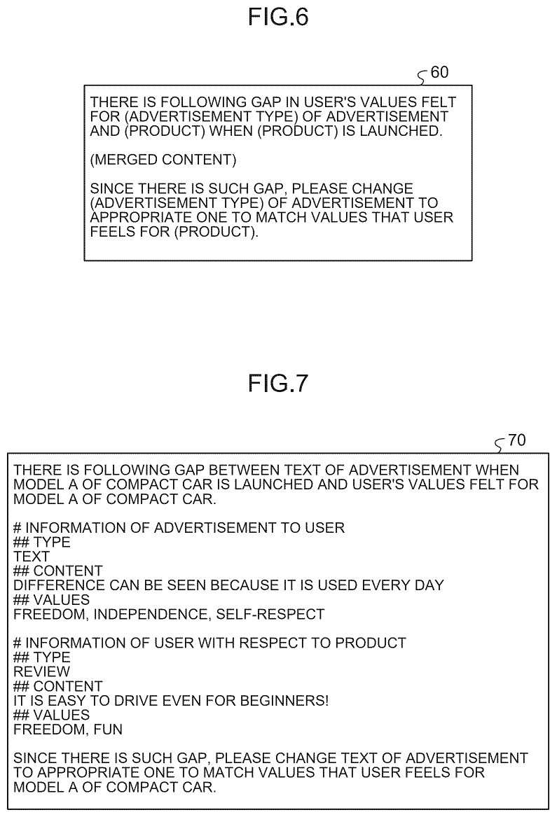

FIG. 6 is a diagram illustrating an example of template information used by the generation unit 34 in the processing unit 12 of the information processing apparatus 1 according to the embodiment. FIG. 7 is a diagram illustrating an example of a prompt generated by the generation unit 34 in the processing unit 12 of the information processing apparatus 1 according to the embodiment using the template information illustrated in FIG. 6.

In a case where the improvement directionality indicated by the improvement directionality information is directionality of improvement to be closer to an impression that the user U is determined to have had, the generation unit 34 generates a prompt using template information 60 illustrated in FIG. 6.

The template information 60 illustrated in FIG. 6 is information of a character string “There is the following gap in the user's values felt for (advertisement type) of an advertisement and (product) when (product) is launched. ¥n¥n(merged content) ¥n¥n Since there is such a gap, please change the (advertisement type) of the advertisement to an appropriate one to match the values that the user feels for (product)”.

In the template information 60 illustrated in FIG. 6, “(product)” is information indicating a specific target. “(Product)” is information indicating a product name or the like in a case where the specific target is a product, and “(Product)” is information indicating a service name or the like in a case where the specific target is a service.

In FIG. 6, “(advertisement type)” is information indicating the type of target information. “(Advertisement Type)” is “text” in a case where the type of target information is character string, and “(Advertisement Type)” is “image” in a case where the type of target information is image. Furthermore, in FIG. 6, “(merged content)” is the merge information generated by the generation unit 34.

In a case where “(product)” is “model A of compact car”, “(advertisement type)” is “text”, and “(merged content)” is the merge information illustrated in FIG. 5, the generation unit 34 generates a prompt 70 illustrated in FIG. 7, for example.

In a case where the improvement directionality indicated by the improvement directionality information is directionality of improvement to be closer to an impression that the user U is estimated to have, the generation unit 34 generates a prompt using template information 61 illustrated in FIG. 7.

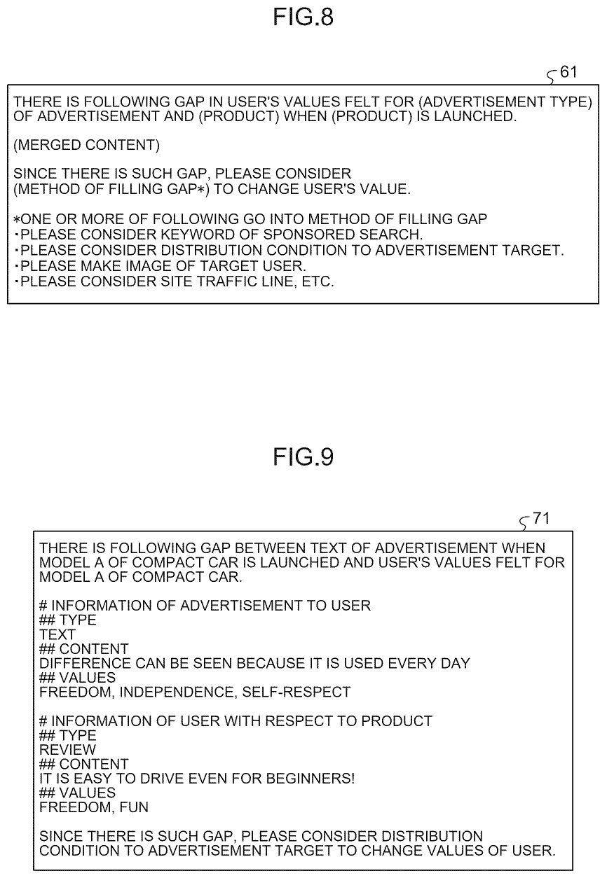

FIG. 8 is a diagram illustrating another example of template information used by the generation unit 34 in the processing unit 12 of the information processing apparatus 1 according to the embodiment. FIG. 9 is a diagram illustrating an example of a prompt generated by the generation unit 34 in the processing unit 12 of the information processing apparatus 1 according to the embodiment using the template information illustrated in FIG. 8.

The template information 61 illustrated in FIG. 8 is information of a character string “There is the following gap in the user's values felt for (advertisement type) of an advertisement and (product) when (product) is launched. ¥n¥n (merged content) ¥n¥n Since there is such a gap, please consider (method of filling gap*) to change the user's values. ¥n\n* one or more of the following go into *method of filling gap¥n. Please consider a keyword of a sponsored search. ¥n. Please consider a distribution condition to an advertisement target. ¥n. Please make an image of the target user. ¥n. Please consider a site traffic line, etc.”

In the template information 61 illustrated in FIG. 8, “(product)” is information indicating a specific target. “(Product)” is information indicating a product name or the like in a case where the specific target is a product, and “(Product)” is information indicating a service name or the like in a case where the specific target is a service.

Furthermore, in FIG. 8, “(advertisement type)” is information indicating the type of target information. “(Advertisement Type)” is information of a character string “text” in a case where the type of target information is character string, and “(Advertisement Type)” is information of a character string “image” in a case where the type of target information is image. Furthermore, in FIG. 8, “(merged content)” is merge information generated by the generation unit 34.

In a case where “(product)” is “model A of compact car”, “(advertisement type)” is “text”, and “(merged content)” is the merge information illustrated in FIG. 5, the generation unit 34 generates a prompt 71 illustrated in FIG. 9, for example.

In the prompt 71 illustrated in FIG. 9, “Please consider conditions for distribution to advertisement targets.” among “Please consider a keyword of a sponsored search.”, “Please consider a distribution condition to an advertisement target.”, “Please make an image of the target user.”, and “Please consider a site traffic line, etc.” is selected as the method of filling the gap.

For example, the generation unit 34 can input information including the information indicating a specific target, the information indicating the type of target information, the merge information, the template information 61, and the instruction information to the generative AI as input information, and output a prompt from the generative AI. In this case, the instruction information is, for example, the information indicating a specific target, the information indicating the type of target information, and the information instructing output of a prompt from merge information by using the template information 61.

Furthermore, the generation unit 34 has information in which the type of the method of filling one or more gaps and the type of the specific target are associated with each other, and can also generate a prompt on a rule basis on the basis of the information indicating the method of filling one or more gaps according to the type of the specific target, the information indicating the specific target, the information indicating the type of target information, the merge information, and the template information 61.

For example, the generation unit 34 can input the prompt 70 illustrated in FIG. 7 to the generative AI and cause the generative AI to output the improvement information including the target information after one or more improvements. Furthermore, the generation unit 34 can input the prompt 71 illustrated in FIG. 9 to the generative AI, for example, and cause the generative AI to output the improvement information including the information indicating the provision method after one or more improvements of the target information.

Furthermore, the template information 60 illustrated in FIG. 6 is information used for generating a prompt for outputting the target information after improvement, but may be information used for generating a prompt for outputting information indicating the provision method after improvement or information indicating the method of improving the target information. Similarly, the template information 61 illustrated in FIG. 8 is information used for generating a prompt for outputting the information indicating the provision method after improvement, but may be information used for generating a prompt for outputting the target information after improvement or the information indicating the method of improving the target information.

In addition, the generation unit 34 also includes, as template information for each directionality of improvement of the target information, template information of intermediate directionality of improvement between the impression that the user U is estimated to have and the impression that the user U is determined to have had, template information of directionality of improvement indicating the degree of closeness (for example, 70% close) to the impression that the user U is estimated to have, template information of directionality of improvement indicating the degree of closeness (for example, 80% close) to the impression that the user U is determined to have had, and the like.

The template information of directionality of improvement indicating the degree of closeness (for example, 70% close) to the impression that the user U is estimated to have is, for example, information of a character string “Please consider (method of filling gap*) to change the user's values so as to be close, by a degree of (ratio), to the user's values felt for (advertisement type) and (product) of an advertisement when (product) is launched with respect to values that the user feels for (product).”, but is not limited to such an example. “(Ratio)” is 80% in a case where it is close to 70%.

Furthermore, the template information of directionality of improvement indicating the degree of closeness (for example, 80% close) to the impression that the user U is determined to have had is, for example, information of a character string “Please change (advertisement type) of an advertisement to an appropriate one so as to be close, by a degree of (ratio), to the values that the user feels for (product) with respect to the user's values felt for (advertisement type) and (product) of an advertisement when (product) is sold.”, but is not limited to such an example. “(Ratio)” is 70% in a case where it is close to 80%.

Furthermore, in a case where the degree of the impression that the user U is estimated to have by the estimation unit 32 is estimated for each impression, the generation unit 34 can include information indicating the degree of each impression estimated by the estimation unit 32 in the merge information. Similarly, in a case where the degree of impression that the user U is determined to have had by the determination unit 33 is estimated for each impression, the generation unit 34 can include information indicating the degree of each impression determined by the determination unit 33 in the merge information.

The generation unit 34 can also generate, for example, impression information before and after improvement that is information (for example, a radar chart or the like) indicating a change in the degree of each impression that the user U is estimated to have by the estimation unit 32 before and after improvement by the improvement information.

Furthermore, the generation unit 34 can also generate, for example, information that is information (for example, a radar chart or the like) indicating a change in the degree of each impression that the user U is determined to have had before and after improvement according to the improvement information by the determination unit 33, as the impression information before and after improvement.

Furthermore, the generation unit 34 can also generate, as time-series information, impression change information (for example, a radar chart, a line graph, a bar graph, or the like) indicating a temporal change in the degree of each impression that the user U is estimated to have by the estimation unit 32.

Furthermore, the generation unit 34 can also generate, as time-series information, impression change information (for example, a radar chart, a line graph, a bar graph, or the like) indicating a temporal change in the degree of each impression that the user U is determined to have had by the determination unit 33.

Furthermore, the generation unit 34 can also generate, as impression deviation information, information that is information (for example, a radar chart or the like) indicating a comparison between the degree of each impression that the user U is estimated to have by the estimation unit 32 and the degree of each impression that the user U is determined to have had by the determination unit 33.

### 3.3.6. Provision Unit 35

The provision unit 35 provides various types of information. For example, the provision unit 35 provides various information to the operator O by transmitting various information to the terminal device 3.

For example, the provision unit 35 provides the operator O with the improvement information generated by the generation unit 34. For example, the provision unit 35 provides the operator O with the improvement information generated by the generation unit 34 by transmitting the improvement information generated by the generation unit 34 to the terminal device 3.

In addition, the provision unit 35 transmits, to the terminal device 3, information selected by the operator O among the impression information before and after improvement, the impression change information, and the impression deviation information generated by the generation unit 34, so that the information selected by the operator O among the impression information before and after improvement, the impression change information, and the impression deviation information generated by the generation unit 34 can be provided to the operator O.

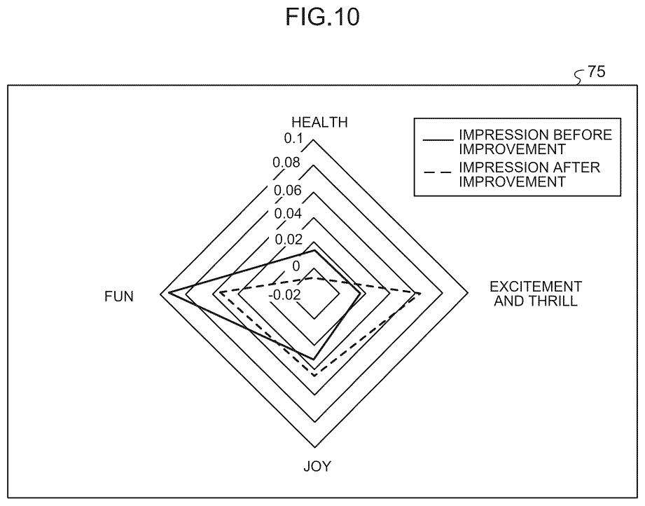

FIG. 10 is a diagram illustrating an example of the impression information before and after improvement provided by the provision unit 35 in the processing unit 12 of the information processing apparatus 1 according to the embodiment. In the example illustrated in FIG. 10, in order to make the description easy to understand, the impressions IM1 to IMm are set to four of health, fun, joy, and excitement and thrill, and the degree of impression is 0.1 to −0.02, but are not limited to such an example.

Impression information before and after improvement 75 illustrated in FIG. 10 indicates a radar chart indicating the degree of each impression determined by the determination unit 33 that the user U is determined to have had before and after improvement by the improvement information. In the example illustrated in FIG. 10, as the impression that the user U is determined to have had, the degree of excitement and thrill is high before improvement by the improvement information, but the degree of enjoyment and health is high after improvement by the improvement information. In this manner, the impression that the user U has had can be changed by the improvement information generated by the information processing apparatus 1.

### 4. Processing Procedure

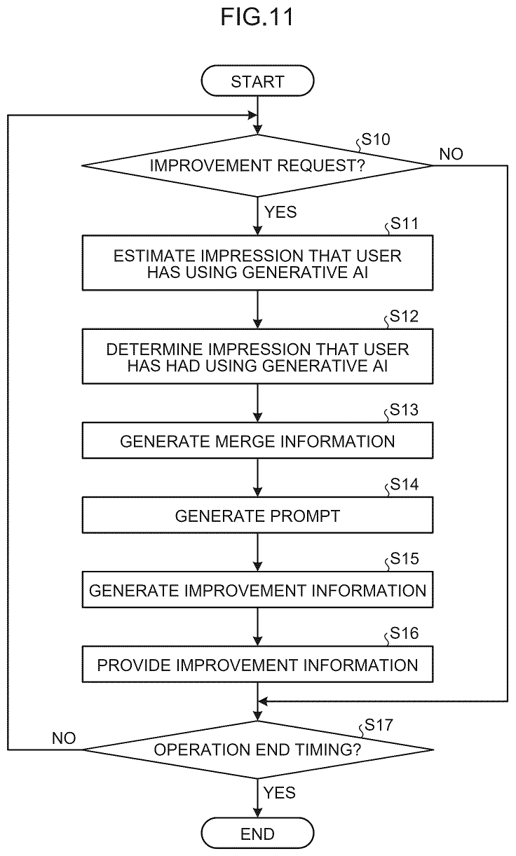

Next, a procedure of information processing by the processing unit 12 of the information processing apparatus 1 according to the embodiment will be described. FIG. 11 is a flowchart illustrating an example of information processing by the processing unit 12 of the information processing apparatus 1 according to the embodiment.

As illustrated in FIG. 11, the processing unit 12 of the information processing apparatus 1 determines whether or not an improvement request has been received (Step S10). In a case where it is determined that the improvement request has been received (Step S10: Yes), the processing unit 12 estimates the impression that the user U has on the basis of the target information included in the improvement request using the generative AI (Step S11).

Subsequently, the processing unit 12 determines the impression that the user U has had using the generative AI on the basis of the user action information corresponding to the user specifying information included in the improvement request (Step S12).

Subsequently, the processing unit 12 generates merge information obtained by merging the estimation result in Step S11 and the determination result in Step S12 (Step S13). Then, the processing unit 12 generates a prompt including the merge information generated in Step S13 (Step S14).

Subsequently, the processing unit 12 inputs the prompt generated in Step S14 to the generative AI and causes the generative AI to output the improvement information, thereby generating the improvement information (Step S15). Then, the processing unit 12 provides the improvement information generated in Step S15 (Step S16).

In a case where the processing of Step S16 is finished or in a case where it is determined that the improvement request is not received (Step S10: No), the processing unit 12 determines whether or not an operation end timing has come (Step S17). For example, in a case where the power of the information processing apparatus 1 is turned off, the processing unit 12 determines that the operation end timing has come.

In a case where it is determined that the operation end timing has not come (Step S17: No), the processing unit 12 shifts the processing to Step S10, or in a case where it is determined that the operation end timing has come (Step S17: Yes), the processing illustrated in FIG. 11 ends.

### 5. Modification

In the above-described example, the generation unit 34 generates the prompt by using the generative AI, but it is also possible to have a prompt for each combination of the type of the specific target, the type of the target information, and the improvement directionality indicated by the improvement directionality information, and select a prompt according to the combination of the type of the specific target, the type of the target information, and the improvement directionality indicated by the improvement directionality information. In this case, the generation unit 34 can also cause the generative AI to output the improvement information by using the selected prompt.

Furthermore, for example, the generation unit 34 can generate or select template information according to a time-series change in each impression determined by the determination unit 33, and generate a prompt using the generated or selected template information.

The impression group used in the estimation unit 32 and the determination unit 33 is a predetermined impression group, but may be an impression group selected by the operator O. Furthermore, the estimation unit 32 and the determination unit 33 have information of an impression group different for each action or attribute of the user U indicated by the user specifying information, and can use an impression group corresponding to the action or attribute of the user U indicated by the user specifying information. Furthermore, the estimation unit 32 and the determination unit 33 have information of an impression group different for each type of the specific target, and can use an impression group corresponding to the type of the specific target.

### 6. Hardware Configuration

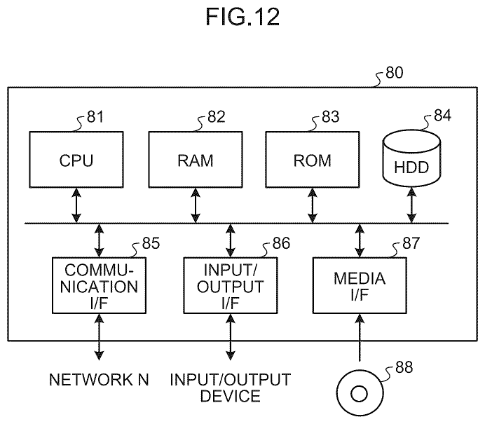

The information processing apparatus 1 according to the above-described embodiment is implemented by a computer 80 having a configuration as illustrated in FIG. 12, for example. FIG. 12 is a hardware configuration diagram illustrating an example of a computer 80 that implements the functions of the information processing apparatus 1 according to the embodiment. The computer 80 includes a CPU 81, a RAM 82, a read only memory (ROM) 83, a hard disk drive (HDD) 84, a communication interface (I/F) 85, an input/output interface (I/F) 86, and a media interface (I/F) 87.

The CPU 81 operates on the basis of a program stored in the ROM 83 or the HDD 84, and controls each unit. The ROM 83 stores a boot program executed by the CPU 81 when the computer 80 is started, a program depending on hardware of the computer 80, and the like.

The HDD 84 stores a program executed by the CPU 81, data used by the program, and the like. The communication interface 85 receives data from other devices via the network N (see FIG. 2), sends the data to the CPU 81, and transmits data generated by the CPU 81 to other devices via the network N.

The CPU 81 controls output devices such as a display and a printer, and input devices such as a keyboard and a mouse via the input/output interface 86. The CPU 81 acquires data from the input device via the input/output interface 86. Furthermore, the CPU 81 outputs the generated data to the output device via the input/output interface 86.

The media interface 87 reads a program or data stored in the recording medium 88 and provides the program or data to the CPU 81 via the RAM 82. The CPU 81 loads the program from the recording medium 88 onto the RAM 82 via the media interface 87, and executes the loaded program. The recording medium 88 is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 80 functions as the information processing apparatus 1 according to the embodiment, the CPU 81 of the computer 80 implements the function of the processing unit 12 by executing the program loaded on the RAM 82. Furthermore, the HDD 84 stores data in the storage unit 11. The CPU 81 of the computer 80 reads and executes these programs from the recording medium 88, but as another example, these programs may be acquired from another device via the network N.

### 7. Others

Among the processes described in the above embodiments, all or a part of the processes described as being automatically performed can be manually performed, or all or a part of the processes described as being manually performed can be automatically performed by a known method. In addition, the processing procedure, specific name, and information including various data and parameters illustrated in the document and the drawings can be arbitrarily changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in any unit according to various loads, usage conditions, and the like.

For example, the above-described information processing apparatus 1 may be implemented by a terminal device and a server computer, may be implemented by a plurality of server computers, or may be implemented by calling an external platform or the like with an API, network computing, or the like depending on functions, so that the configuration can be flexibly changed.

In addition, the above-described embodiments and modifications can be appropriately combined within a range in which the contents of processing do not contradict each other.

### 8. Effects

As described above, the information processing apparatus 1 according to the embodiment includes the target related information acquisition unit 40, the user information acquisition unit 41, and the generation unit 34. The target related information acquisition unit 40 acquires target information including information of the specific target and target impression information indicating an impression that the user U is estimated to have on the specific target. The user information acquisition unit 41 acquires user impression information indicating an impression that the user U is determined to have had on the target information. The generation unit 34 generates improvement information including information indicating improvement content related to the target information on the basis of the target information and the target impression information acquired by the target related information acquisition unit 40 and the user impression information acquired by the user information acquisition unit 41. Thus, the information processing apparatus 1 can improve convenience on the provision side of the specific target.

Furthermore, the information processing apparatus 1 includes the reception unit 30 that receives improvement directionality information indicating a directionality of improvement of the target information, and the generation unit 34 generates the improvement information on the basis of the information further including the improvement directionality information received by the reception unit 30. Thus, the information processing apparatus 1 can further improve convenience on the provision side of the specific target.

Furthermore, the directionality of improvement of the target information includes directionality of improvement to be closer to the impression that the user U is estimated to have and directionality of improvement to the impression that the user U is determined to have had. Thus, the information processing apparatus 1 can further improve convenience on the provision side of the specific target.

In addition, the generation unit 34 generates the improvement information using the generative AI. Thus, the information processing apparatus 1 can generate the improvement information with high accuracy.

Furthermore, the information processing apparatus 1 includes the determination unit 33 that determines the impression that the user U has had on the basis of the information of the user U regarding the specific target. Thus, the information processing apparatus 1 can further improve convenience on the provision side of the specific target.

Furthermore, the determination unit 33 determines the impression that the user U has had on the basis of the posted message of the user U with respect to the specific target. Thus, the information processing apparatus 1 can further improve convenience on the provision side of the specific target.

The information processing apparatus 1 includes an estimation unit 32 that estimates an impression that the user U is estimated to have on the basis of the target information. Thus, the information processing apparatus 1 can further improve convenience on the provision side of the specific target.

The target information is an advertisement of a specific target. Thus, the information processing apparatus 1 can further improve convenience on the provision side of the specific target.

Furthermore, the target information is a catch phrase of a specific target. Thus, the information processing apparatus 1 can further improve convenience on the provision side of the specific target.

Furthermore, the generation unit 34 inputs information including the target information, the target impression information, the user impression information, and the instruction information according to the improvement directionality information to the generative AI as input information, and outputs the improvement information from the generative AI. Thus, the information processing apparatus 1 can further improve convenience on the provision side of the specific target.

Although the embodiment of the present application has been described in detail with reference to the drawings, this is merely an example, and the present invention can be implemented in other forms to which various modifications and improvements have been made on the basis of the knowledge of those skilled in the art, including the aspects described in the disclosure of the invention.

In addition, the “Part (section, module, or unit)” described above can be read as “means”, “circuit”, or the like. For example, the acquisition unit can be replaced with an acquisition unit or an acquisition circuit.

According to one aspect of the embodiment, there is an effect that convenience of a provision side of a specific target can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a target related information acquisition unit that acquires target information including information of a specific target and target impression information indicating an impression that a user is estimated to have on the specific target;
a user information acquisition unit that acquires user impression information indicating an impression that the user is determined to have had on the target information; and
a generation unit that generates improvement information including information indicating improvement content related to the target information on a basis of the target information and the target impression information acquired by the target related information acquisition unit and the user impression information acquired by the user information acquisition unit.

2. The information processing apparatus according to claim 1, comprising:
a reception unit that receives improvement directionality information indicating directionality of improvement of the target information, wherein
the generation unit
generates the improvement information on a basis of information further including the improvement directionality information received by the reception unit.

3. The information processing apparatus according to claim 2, wherein
the directionality of improvement of the target information is
directionality of improvement to be closer to an impression that the user is estimated to have and directionality of improvement to be closer to an impression that the user is determined to have had.

4. The information processing apparatus according to claim 1, wherein
the generation unit
generates the improvement information using generative AI.

5. The information processing apparatus according to claim 1, comprising:
a determination unit that determines an impression that the user has had on a basis of information of the user regarding the specific target.

6. The information processing apparatus according to claim 5, wherein
the determination unit
determines an impression that the user has had on a basis of a posted message of the user with respect to the specific target.

7. The information processing apparatus according to claim 1, comprising:
an estimation unit that estimates an impression that the user is estimated to have on a basis of the target information.

8. The information processing apparatus according to claim 1, wherein
the target information
is an advertisement of the specific target.

9. The information processing apparatus according to claim 8, wherein
the target information
is a catch phrase of the specific target.

10. The information processing apparatus according to claim 2, wherein
the generation unit
inputs information including the target information, the target impression information, the user impression information, and instruction information according to the improvement directionality information to generative AI as input information, and outputs the improvement information from the generative AI.

11. An information processing method executed by a computer, the method comprising:
acquiring target information including information of a specific target and target impression information indicating an impression that a user is estimated to have on the specific target;
acquiring user impression information indicating an impression that the user is determined to have had on the target information; and
generating improvement information including information indicating improvement content related to the target information on a basis of the target information and the target impression information and the user impression information.

12. A non-transitory computer readable storage medium having stored therein an information processing program for causing a computer to execute:
acquiring target information including information of a specific target and target impression information indicating an impression that a user is estimated to have on the specific target;
acquiring user impression information indicating an impression that the user is determined to have had on the target information; and
generating improvement information including information indicating improvement content related to the target information on a basis of the target information and the target impression information and the user impression information.
